(19) United States
(12) Patent Application Publication
(10) Pub. No.: US 2023/0250113 A1
(43) Pub. Date: Aug. 10, 2023

(54) SILIRANE-FUNCTIONALISED COMPOUNDS, IN PARTICULAR ORGANOSILICON COMPOUNDS, FOR PREPARING SILOXANES

(71) Applicant: WACKER CHEMIE AG, Munich (DE)

(72) Inventors: Jan TILLMANN, Munich (DE); Fabian Andreas David HERZ, Berg (DE); Bernhard RIEGER, Elchingen (DE); Richard WEIDNER, Burghausen (DE); Daniel Wolfgang WENDEL, Munich (DE)

(73) Assignee: Wacker Chemie AG, Munich (DE)

(21) Appl. No.: 17/781,062

(22) PCT Filed: Dec. 4, 2019
(86) PCT No.: PCT/EP2019/083737

§ 371 Date: Sep. 22, 2022

(51) Int. Cl. C07F 7/08; C07F 7/21; C08G 77/38; C08G 77/44

(52) U.S. Cl. CPC C07F 7/0807; C07F 7/21; C07F 7/083; C08G 77/38; C08G 77/44

(57) ABSTRACT

A silirane-functionalized compound, a process for preparing the same, and a process for preparing siloxanes using a silirane-functionalized compound are described herein.

The invention relates to silirane-functionalized compounds, to a process for preparing them and to a process for preparing siloxanes with these silirane-functionalized compounds.

### PRIOR ART AND TECHNICAL OBJECT

Silicones are of great interest on account of their outstanding chemical and physical properties and are therefore used diversely. In contrast to the situation with carbon-based plastics, the van der Waals forces between homopolymer chains in siloxanes are very weak. In siloxane homopolymers this leads to flow behavior and poor mechanical properties, even at very high molecular weights. For this reason, siloxane chains are crosslinked, and thereby acquire their rubber-elastic condition.

There are a number of processes known for the linking of siloxanes; a distinction is made fundamentally between addition reactions, condensation reactions, and radical reactions. In the case of addition crosslinking, for example, vinyl-functionalized siloxanes react with hydridosiloxanes without elimination product in a reaction referred to as hydrosilylation (RTV-2, LSR or HTV). The reaction requires the use of noble metal catalysts (usually platinum), which remain in the polymer and cannot be recovered. In the case of condensation crosslinking, terminal silanol groups are reacted with one another or with other silicon-functional groups (e.g., Si—O—CH₃, Si—O—C₂H₅, Si—O—C(═O)—CH₃). The reaction is accompanied by elimination of small, volatile compounds such as water, acetic acid or alcohol, for example, and hence also by a physical contraction. Condensation-crosslinking systems may be operated as one-component systems, activated by contact with small amounts of water (RTV-1). The mixtures are normally admixed with a metal catalyst (e.g., Sn-based) to accelerate the crosslinking reaction. In the case of radical peroxide crosslinking, organic peroxides are used which on heating break down into radicals (HTV). The reactive radicals crosslink, for example, vinylmethylsiloxanes.

In Macromolecules 2003, 36, 1474-1479, it was shown that monofunctional siliranes can be polymerized anionically.

Semenov et al. in (a) Russian Journal of Applied Chemistry 2002, 75 (1), 127-134, (b) Russian Chemical Reviews 2011, 80 (4), 3313-339, and (c) Applied Organometallic Chemistry 1990, 4, 163-172, describe oligodimethylsilanes as a source of photochemically generated silylenes for the crosslinking of silanol-terminated vinylmethylsiloxanes. The crosslinking takes place with the highly reactive silylene forming a silirane with a vinyl group, said silirane being able subsequently to react with a silanol group. During a crosslinking, the siliranes formed were not detected, and the correctness of the mechanism is therefore questionable. Moreover, because of the low UV penetration, the method is possible only with very low film thicknesses (˜100 μm film).

Known from Von Fink et al., from Journal of Organometallic Chemistry 2011, 696, 1957-1963, moreover, are the following difunctional bis-silirane compounds:

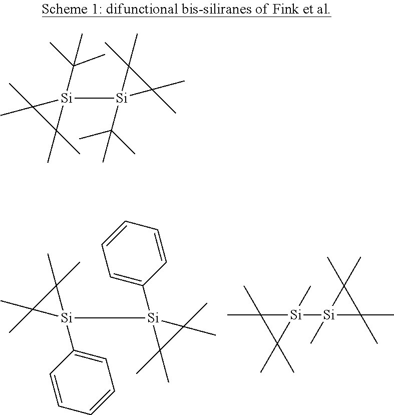

Additionally it is known from WO2015/088901 that monosiliranes can be used for the surface functionalization of substrates terminated by OH groups, NH₂ groups or NH groups.

Other polyfunctional siliranes, namely compounds having two or more silirane groups in the molecule, are unknown in the literature. The use thereof for the formation of siloxane bonds is likewise unknown.

Accordingly, there continues to be need for the provision of a process for preparing siloxanes that does not have the disadvantages of the existing processes, such as elimination products or use of metal catalysts.

This object is achieved by the silirane-functionalized organosilicon compounds of the invention of claims 1-4, by their preparation process according to claims 5-10, and by the reaction of the silirane-functionalized organosilicon compounds with functionalized siloxanes according to claims 11-13.

A subject of the invention are silirane-functionalized compounds consisting of a substrate to which at least two silirane groups of the formula (I)

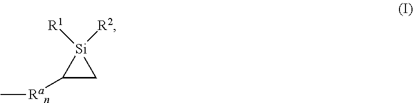

are covalently bonded,

where in formula (I) the index n adopts a value of 0 or 1,

and where the radical R^{a} is a divalent C₁-C₂₀ hydrocarbon radical, and where the radicals R¹ and R² independently of one another are selected from the group consisting of (i) hydrogen, (ii) C₁-C₂₀ hydrocarbon radical, (iii) silyl radical —SiR^{a}R^{b}R^{c}, in which the radicals R^{a},R^{b},R^{c} independently of one another are a C₁-C₆ hydrocarbon radical, (iv) amine radical —NR′R″, in which the radicals R′,R″ independently of one another are selected from the group consisting of (iv.i) hydrogen, (iv.ii) C₁-C₂₀ hydrocarbon radical and (iv.iii) silyl radical —SiR^{a}R^{b}R^{c}, in which the radicals R^{a},R^{b},R^{c} independently of one another are a C₁-C₆ hydrocarbon radical, and (v) imine radical —N═CR¹R², in which the radicals R¹,R² independently of one another are selected from the group consisting of (v.i) hydrogen, (v.ii) C₁-C₂₀ hydrocarbon radical and (v.iii) silyl radical —SiR^{a}R^{b}R^{c}, in which the radicals R^{a},R^{b},R^{c} independently of one another are a C₁-C₆ hydrocarbon radical.

The substrate is preferably selected from the group consisting of organosilicon compounds, hydrocarbons, silicas, glass, sand, stone, metals, semimetals, metal oxides, mixed metal oxides, and carbon-based oligomers and polymers.

The substrate is more preferably selected from the group consisting of silanes, siloxanes, precipitated silica, fumed silica, glass, hydrocarbons, polyolefins, acrylates, polyacrylates, polyvinyl acetates, polyurethanes and polyethers composed of propylene oxide and/or ethylene oxide units.

Preferred silirane-functionalized compounds are those where in formula (I) the radicals R¹ and R² are selected from the group consisting of (i) hydrogen, (ii) C₁-C₆-alkyl radical, (iii) phenyl radical, (iv) —SiMe₃, and (v) —N(SiMe₃)₂. Particularly preferred silirane-functionalized compounds are those where in formula (I) the radicals R¹ and R² are selected from the group consisting of methyl, ethyl, tert-butyl, sec-butyl, cyclohexyl, —SiMe₃, and —N(SiMe₃)₂.

A particular embodiment of the invention are silirane-functionalized organosilicon compounds selected from the group consisting of

(a) compounds of the general formula (II)

SiR′ₙR₄₋ₙ (II),

in which the index n adopts the value of 2, 3 or 4, and the radicals R independently of one another are selected from the group consisting of (i) hydrogen, (ii) halogen, (iii) unsubstituted or substituted C₁-C₂₀ hydrocarbon radical and (iv) unsubstituted or substituted C₁-C₂₀ hydrocarbonoxy radical;

and in which the radicals R′ are a silirane group of the formula (II′)

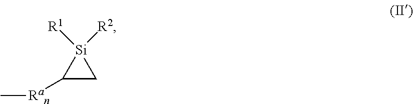

in which the index n adopts the value of 0 or 1;

in which the radical R^{a} is a divalent C₁-C₂₀ hydrocarbon radical;

and in which the radicals R¹ and R² independently of one another are selected from the group consisting of (i)

hydrogen, (ii) C₁-C₂₀ hydrocarbon radical, (iii) silyl radical —SiR^{a}R^{b}R^{c}, in which the radicals R^{a},R^{b},R^{c} independently of one another are a C₁-C₆ hydrocarbon radical, (iv) amine radical —NR′R″, in which the radicals R′,R″ independently of one another are selected from the group consisting of (iv.i) hydrogen, (iv.ii) C₁-C₂₀ hydrocarbon radical and (iv.iii) silyl radical —SiR^{a}R^{b}R^{c}, in which the radicals R^{a},R^{b},R^{c} independently of one another are a C₁-C₆ hydrocarbon radical, and (v) imine radical —N═CR¹R², in which the radicals R¹,R² independently of one another are selected from the group consisting of (v.i) hydrogen, (v.ii) C₁-C₂₀ hydrocarbon radical and (v.iii) silyl radical —SiR^{a}R^{b}R^{c}, in which the radicals R^{a},R^{b},R^{c} independently of one another are a C₁-C₆ hydrocarbon radical; or

(b) compounds of the general formula (III)

(SiO_{4/2})ₐ(R^{x}SiO_{3/2})_{b}(R′SiO_{3/2})_{b′}(R^{x}SiO_{2/2})_{c}(R^{x}R′SiO_{2/2})_{c′}(R′₂SiO_{2/2})_{c″}(R^{x}₃SiO_{1/2})_{d}(R′R^{x}₂SiO_{1/2})_{d′}(R′₂R^{x}SiO_{1/2})_{d″}(R′₃SiO_{1/2})_{d′″} (III),

in which the radicals R^{x} independently of one another are selected from the group consisting of (i) hydrogen, (ii) halogen, (iii) unsubstituted or substituted C₁-C₂₀ hydrocarbon radical and (iv) unsubstituted or substituted C₁-C₂₀ hydrocarbonoxy radical;

and in which the indices a, b, c, c′, c″, d, d′, d″, d′″ indicate the number of the respective siloxane unit in the compound and independently of one another are an integer in the range from 0 to 100 000, with the proviso that the sum of a, b, b′, c, c′, c″, d, d′, d″, d′″ together adopts a value of at least 2 and at least one of the indices b′, c′, d′ is ≥2 or at least one of the indices c″, d″ or d′″ is other than 0; and the radicals R′ are a silirane group of the formula (III′)

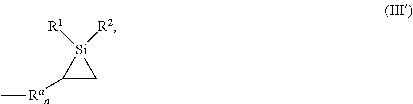

in which the index n adopts the value of 0 or 1;

in which the radical R^{a} is a divalent C₁-C₂₀ hydrocarbon radical; and in which the radicals R¹ and R² independently of one another are selected from the group consisting of (i)

hydrogen, (ii) C₁-C₂₀ hydrocarbon radical, (iii) silyl radical —SiR^{a}R^{b}R^{c}, in which the radicals R^{a},R^{b},R^{c} independently of one another are a C₁-C₆ hydrocarbon radical, (iv) amine radical —NR′R″, in which the radicals R′,R″ independently of one another are selected from the group consisting of (iv.i) hydrogen, (iv.ii) C₁-C₂₀ hydrocarbon radical and (iv.iii) silyl radical —SiR^{a}R^{b}R^{c}, in which the radicals R^{a},R^{b},R^{c} independently of one another are a C₁-C₆ hydrocarbon radical, and (v) imine radical —N═CR¹R², in which the radicals R¹,R² independently of one another are selected from the group consisting of (v.i) hydrogen, (v.ii) C₁-C₂₀ hydrocarbon radical and (v.iii) silyl radical —SiR^{a}R^{b}R^{c}, in which the radicals R^{a},R^{b},R^{c} independently of one another are a C₁-C₆ hydrocarbon radical.

Preferred silirane-functionalized organosilicon compounds are those where additionally

(a) in formula (II) the index n adopts the value of 4 and in formula (II′) the radicals R¹ and R² are selected from the group consisting of (i) hydrogen, (ii) C₁-C₆ alkyl radical, (iii) phenyl radical, (iv) —SiMe₃, and (v) —N(SiMe₃)₂; and

(b) in formula (III) and the radicals R^{x} independently of one another are selected from the group consisting of (i) hydrogen, (ii) chlorine, (iii) C₁-C₆-alkyl, (iv) C₁-C₆ alkylene, (v) phenyl, and (vi) C₁-C₆ alkoxy, and in formula (III′) the radicals R¹ and R² are selected from the group consisting of (i) hydrogen, (ii) C₁-C₆ alkyl radical, (iii) phenyl radical, (iv) —SiMe₃, and (v) —N(SiMe₃)₂.

Particularly preferred silirane-functionalized organosilicon compounds are those where additionally

(a) in formula (II) the radicals R′ are identical, and in formula (II′) the radical R^{a} is a divalent C₁-C₃ hydrocarbon radical and the radicals R¹ and R² independently of one another are selected from the group consisting of methyl, ethyl, tert-butyl, sec-butyl, cyclohexyl, —SiMe₃, and —N(SiMe₃)₂; and

(b) in formula (III) the radicals R^{x} independently of one another are selected from the group consisting of methyl, methoxy, ethyl, ethoxy, propyl, propoxy, phenyl and chlorine, and in formula (III′) the radical R^{a} is a divalent C₁-C₃ hydrocarbon radical and the radicals R¹ and R² independently of one another are selected from the group consisting of methyl, ethyl, tert-butyl, sec-butyl, cyclohexyl, —SiMe₃, and —N(SiMe₃)₂.

Especially preferred silirane-functionalized organosilicon compounds are those where additionally in formula (III) either

(b1) the indices a, b, b′, c″, d, d′, d″, d′″ adopt a value of 0, with the proviso that c′ is ≥2; or

(b2) the indices a, b, and b′ adopt a value of 0.

Preferred linear polysiloxanes for the above case (b2) are:

R^{x}₃Si—O[—SiR^{x}₂—O]ₘ[SiR′R^{x}—O]₂—SiR^{x}₃ (IIIa),

R′R^{x}₂Si—O[—SiR^{x}₂—O]ₘ—[SiR′R^{x}—O]ₙ—SiR^{x}₂R′ (IIIb),

R′R^{x}₂Si—O[—SiR^{x}₂—O]ₘ—SiR^{x}₂R′ (IIIc),

in which R^{x} and R′ have the same definition as in formula (III) and the indices m and n indicate the mean number of the respective siloxane unit in the compound and independently of one another are each a number in the range from 0 to 100 000.

Preferred cyclic siloxanes for the above case (b1) are:

(R^{x}₂SiO_{2/2})_{c}(R^{x}R′SiO_{2/2})_{c′} (IIId),

in which R^{x}, R′, c and c′ have the same definition as in formula (III).

Particularly preferred cyclic siloxanes are those for which c+c′=4-8, 4-6 with the proviso that c′ is ≥2.

Especially preferred cyclic siloxanes are

(R^{x}R′SiO_{2/2})_{c′} (IIIe),

in which R^{x} and R′ have the same definition as above, and c′=4-8, especially preferably c′=4-6.

Examples of cyclic siloxanes of the formula (IIIe) are: cyclotetrasiloxane, cyclopentasiloxane, cyclohexasiloxane, in each case with R^{x}=methyl and R′=silirane of the formula (II′), in which the radical R^{a} is a divalent C₁-C₃ hydrocarbon radical and the radicals R¹ and R² independently of one another are selected from the group consisting of methyl, ethyl, tert-butyl, sec-butyl, cyclohexyl, —SiMe₃, and —N(SiMe₃)₂.

A further subject of the invention is a process for preparing silirane-functionalized compounds, comprising the steps of

(a) providing a silirane of the general formula (IV)

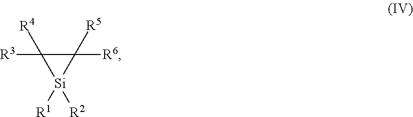

in which the radicals R¹ and R² independently of one another are selected from the group consisting of (i) hydrogen, (ii) C₁-C₂₀ hydrocarbon radical, (iii) silyl radical —SiR^{a}R^{b}R^{c}, in which the radicals R^{a},R^{b},R^{c} independently of one another are a C₁-06 hydrocarbon radical, (iv) amine radical —NR¹R², in which the radicals R¹,R² independently of one another are selected from the group consisting of (iv.i) hydrogen, (iv.ii) C₁-C₂₀ hydrocarbon radical and (iv.iii) silyl radical —SiR^{a}R^{b}R^{c}, in which the radicals R^{a},R^{b},R^{c} independently of one another are a C₁-C₆ hydrocarbon radical, and (v) imine radical —N═CR¹R², in which the radicals R¹,R² independently of one another are selected from the group consisting of (v.i) hydrogen, (v.ii) C₁-C₂₀ hydrocarbon radical and (v.iii) silyl radical —SiR^{a}R^{b}R^{c}, in which the radicals R^{a},R^{b},R^{c} independently of one another are a C₁-C₆ hydrocarbon radical; and in which the radicals R³, R⁴, R⁵, R⁶ independently of one another are selected from the group consisting of (i) hydrogen, (ii) C₁-C₂₀ hydrocarbon radical, and (iii) silyl radical —SiR^{a}R^{b}R^{c}, in which the radicals R^{a},R^{b},R^{c} independently of one another are a C₁-C₆ hydrocarbon radical;

(b) reacting the silirane from (a) with a substrate in that has at least two covalently bonded carbon-carbon double bonds, of the formula —R^{a}ₙ—CR═CR², in which R^{a} is a divalent C₁-C₂₀ hydrocarbon radical and the index n adopts the values 0 or 1, and in which the radicals R independently of one another are selected from the group consisting of (i) hydrogen and (ii) C₁-C₆ hydrocarbon radical.

For the formula —Rₐⁿ—CR═CR² it is preferred for all radicals R to be hydrogen.

A particular embodiment of the invention is a process for preparing silirane-functionalized compounds, comprising the steps of

(a) providing a silirane of the general formula (IV)

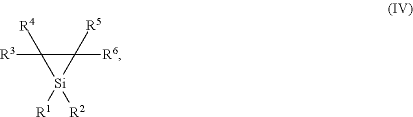

in which the radicals R¹ and R² independently of one another are selected from the group consisting of (i) hydrogen, (ii) C₁-C₂₀ hydrocarbon radical, (iii) silyl radical —SiR^{a}R^{b}R^{c}, in which the radicals R^{a},R^{b},R^{c} independently of one another are a C₁-C₆ hydrocarbon radical, (iv) amine radical —NR¹R², in which the radicals R¹,R² independently of one another are selected from the group consisting of (iv.i) hydrogen, (iv.ii) C₁-C₂₀ hydrocarbon radical and (iv.iii) silyl radical —SiR^{a}R^{b}R^{c}, in which the radicals R^{a},R^{b},R^{c} independently of one another are a C₁-C₆ hydrocarbon radical, and (v) imine radical —N═CR¹R², in which the radicals R¹,R² independently of one another are selected from the group consisting of (v.i) hydrogen, (v.ii) C₁-C₂₀ hydrocarbon radical and (v.iii) silyl radical —SiR^{a}R^{b}R^{c}, in which the radicals R^{a},R^{b},R^{c} independently of one another are a C₁-C₆ hydrocarbon radical; and in which the radicals R³, R⁴, R⁵, R⁶ independently of one another are selected from the group consisting of (i) hydrogen, (ii) C₁-C₂₀ hydrocarbon radical, and (iii) silyl radical —SiR^{a}R^{b}R^{c}, in which the radicals R^{a},R^{b},R^{c} independently of one another are a C₁-C₆ hydrocarbon radical;

(b) reacting the silirane from (a) with a substrate selected from the group consisting of (i) olefinically functionalized silanes of the general formula (V)

SiR⁷ₙR₄-n (V),

in which the index n adopts values of 2, 3 or 4; and in which the radicals R independently of one another are selected from the group consisting of (i) hydrogen, (ii) halogen, (iii) unsubstituted or substituted C₁-C₂₀ hydrocarbon radical and (iv) unsubstituted or substituted C₁-C₂₀ hydrocarbonoxy radical; and

in which the radicals R⁷ independently of one another are selected from radicals —R^{a}ₙ—CR═CR², in which R^{a} is a divalent C₁-C₂₀ hydrocarbon radical and the index n adopts values of 0 or 1 and the radicals R independently of one another are selected from the group consisting of (i) hydrogen and (ii) C₁-C₆ hydrocarbon radical; or

(ii) olefinically functionalized siloxanes of the general formula (VI)

(SiO_{4/2})ₐ(R^{x}SiO_{3/2})_{b}(R⁷SiO_{3/2})_{b′}(R^{x}₂SiO_{2/2})_{c}(R^{x}R⁷SiO_{2/2})_{c′}(R⁷₂SiO_{2/2})_{c″}(R^{x}₃SiO_{1/2})_{d}(R⁷R^{x}₂SiO_{1/2})_{d′}(R⁷₂R^{x}SiO_{1/2})_{d″}(R⁷₃SiO_{1/2})_{d′″} (VI),

in which the radicals RT independently of one another are selected from radicals —R^{a}ₙ—CR═CR², in which R^{a} is a divalent C₁-C₂₀ hydrocarbon radical and the index n adopts values of 0 or 1 and the radicals R independently of one another are selected from the group consisting of (i) hydrogen and (ii) C₁-C₆ hydrocarbon radical; and in which the radicals R^{x} independently of one another are selected from the group consisting of (i) hydrogen, (ii) halogen, (iii) unsubstituted substituted C₁-C₂₀ hydrocarbon radical and (iv) unsubstituted substituted C₁-C₂₀ hydrocarbonoxy radical; and in which the indices a, b, b′, c, c′, c″, d, d′, d″, d′″ indicate the number of the respective siloxane unit in the compound and independently of one another are an integer in the range from 0 to 100 000, with the proviso that the sum of a, b, b′, c, c′, c″, d, d′, d″, d′″ together adopts a value of at least 2 and at least one of the indices b′, c′, d′ is ≥2 or at least one of the indices c″, d″ or d′″ is other than 0; or

(c) allyl- and/or vinyl-terminated polyethers composed of propylene and/or ethylene oxide units.

The preparation of the silirane compounds requires monofunctional siliranes of the formula (IV)

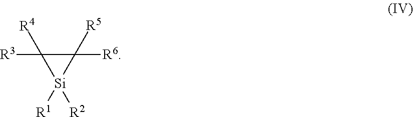

The silyl unit (R¹R²Si:) of this monofunctional silirane is for this purpose transferred onto the C═C double bonds (≥2 C═C double bonds) of an arbitrary substrate; this may take place thermally or catalytically. Suitable substrates include generally organic compounds which possess at least two vinyl groups, or inorganic compounds which have at least two vinyl groups bonded covalently on their surface.

The thermal transfer reaction takes place at temperatures above the decomposition temperature of the monofunctional silirane (e.g., at 140° C. for tBu₂Si(CHMe)₂) in a suitable solvent such as xylene, for example. The olefin formed in this case must be removed—in the case of volatile olefins, for example, by a pressure relief valve or by reduced pressure.

The catalytic transfer of the silyl unit onto the C═C double bonds of the substrate takes place normally without catalyst. It is, though, also possible to add small amounts (e.g., 0.001 equivalent) of catalyst. Catalysts used may be compounds which accelerate the cleavage of the monosubstituted silirane, e.g., Cu(OTf)₂ or AgOTf. The reaction may take place either solvent-free or in a suitable solvent, such as toluene, for example. The temperature is chosen so as to allow the resultant olefin to escape from the solution. The resultant olefin must be removed, by a pressure relief valve or application of reduced pressure, for example.

The reaction is at an end when all of the vinyl groups in the substrate have undergone reaction. Excess monofunctional silirane and the solvent are removed under reduced pressure. For further purification, the polyfunctional siliranes may be filtered through activated carbon and/or Al₂O₃.

An alternative possibility is to use silane compounds such as hexa-tert-butylcyclotrisilane, for example, as a source of the silylene unit. Thermolysis or photolysis generates the corresponding silylene units from the silane, and they are scavenged by the vinyl groups of a polyfunctional vinyl substrate (e.g., tetraallylsilane) as the corresponding polyfunctional silirane.

An alternative possibility is to reduce dihalosilanes to the corresponding silylene units using reducing agents such as lithium or KC₈, these units again being able to be scavenged by polyfunctional vinyl substrates as the corresponding polyfunctional silirane.

Preferably in formula (IV) the radicals R³,R⁴,R⁵,R⁶ independently of one another are selected from the group consisting of (i) hydrogen, (ii) C₁-C₆ hydrocarbon radical, and (iii) silyl radical —SiR^{a}R^{b}R^{c}, in which the radicals R^{a},R^{b},R^{c} independently of one another are a C₁-C₃ hydrocarbon radical. More preferably the radicals R³,R⁴,R⁵,R⁶ independently of one another are selected from the group consisting of hydrogen, methyl and —SiMe₃.

Preference is given to using olefinically functionalized silanes of the formula (V) where the index n adopts a value of 4 and R^{a} is a divalent C₁-C₆ hydrocarbon radical.

Particular preference is given to using olefinically functionalized silanes of the formula (V) where all radicals R⁷ are identical and R^{a} is a divalent C₁-C₃ hydrocarbon.

Preference is given to using olefinically functionalized siloxanes of the formula (VI) where:

(a) the indices a, b, b′, c″, d, d′, d″, d′″ adopt a value of 0, with the proviso that c′ is ≥2; or

(b) the indices a, b, and b′ adopt a value of 0.

Particular preference is given to using olefinically functionalized siloxanes of the formula (VI) where additionally:

(a) c+c′=4-8, with the proviso that c′ is ≥2; or

(b) else the indices c″, d″ and d′″ adopt a value of 0.

Especial preference is given to using olefinically functionalized siloxanes of the formula (VI) where additionally:

(a) c=0; or

(b) else the index d′ adopts the value of 0 and the indices c and c′ are an integer in the range from 0 to 20 000.

A further subject of the invention is a mixture comprising

a) at least one silirane-functionalized compound of the invention; and

b) at least one compound A which has in each case at least two radicals R′, where the radicals R′ independently of one another are selected from the group consisting of (i) —OH, (ii) —CₓH₂ₓ—OH, in which x is an integer in the range of 1-20, (iii) —CₓH₂ₓ—NH₂, in which x is an integer in the range of 1-20, and (iv) —SH.

A particular embodiment of the invention is a mixture where the compound A is selected from functionalized siloxanes of the general formula (VII)

(SiO_{4/2})ₐ(R^{x}SiO_{3/2})_{b}(R′SiO_{3/2})_{b′}(R^{x}₂SiO_{2/2})_{c}(R^{x}R′SiO_{2/2})_{c′}(R′₂SiO_{2/2})_{c″}(R^{x}₃SiO_{1/2})_{d}(R′R^{x}₂SiO_{1/2})_{d′}(R′₂R^{x}SiO_{1/2})_{d″}(R′₃SiO_{1/2})_{d′″} (VII),

where the radicals R^{x} independently of one another are selected from the group consisting of (i) hydrogen, (ii) halogen, (iii) unsubstituted substituted C₁-C₂₀ hydrocarbon radical and (iv) unsubstituted substituted C₁-C₂₀ hydrocarbonoxy radical; and where the radicals R′ independently of one another are selected from the group consisting of (i) —OH, (ii) —CₓH₂ₓ—OH, in which x is an integer in the range of 1-20, (iii) —CₓH₂ₓ—NH₂, in which x is an integer in the range of 1-20, and (iv) —SH; and where the indices a, b, c, c′, c″, d, d′, d″, d′″ indicate the number of the respective siloxane unit in the compound and independently of one another are an integer in the range from 0 to 100 000, with the proviso that the sum of a, b, b′, c, c′, c″, d, d′, d″, d′″ together adopts a value of at least 2 and at least one of the indices b′, c′, d′ is ≥2 or at least one of the indices c″, d″ or d′″ is other than 0.

The mixture may optionally further comprise a catalyst, more particularly a Lewis acid such as Cu(OTf)₂ or tris(pentafluorophenyl)borane (B(C₆F₅)₃) or frustrated Lewis acid base pairs such as triphenylmethyl tetrakis(pentafluorophenyl)borate.

A further subject of the invention is a process for preparing siloxanes, comprising the following steps:

(i) providing a mixture according to the invention, in accordance with the particular embodiment, and

(ii) reacting the mixture at a temperature in the range from 25° C. to 250° C.

The reaction takes place preferably at a temperature in the range from 60° C. to 200° C.

Preference is given to using functionalized dimethylsiloxanes, dimethylpolysiloxanes, diphenylsiloxanes, or diphenylpolysiloxanes. These siloxanes more preferably have a maximum mean chain length of 500.

The reaction of a functionalized siloxane of the general formula (VII) with a silirane-functionalized compound may normally be achieved through thermal activation. In the course of the reaction, a silirane unit reacts with a nucleophilic functional group of the siloxane in a ring-opening reaction. A siloxane bond is formed in this reaction.

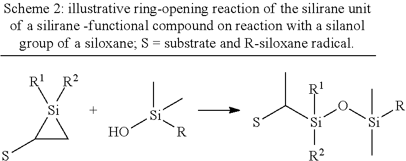

The reaction of silirane-functionalized compounds with functionalized siloxanes of the formula (VII) takes place by homogenous mixing in a suitable molar ratio and subsequent heating. The molar ratio of silirane groups to functional groups in the siloxane is normally in a range of 4:1-1:4, preferably in a range of 1:1-1:4.

The temperature is chosen such that the ring-opening reaction takes place but the silirane-functionalized compound is not destroyed by thermolysis. The temperature is normally in a range of 25-250° C., preferably in a range of 60-200° C., more preferably in a range of 60-130° C.

In the preparation of siloxanes it is also possible to add any desired fillers which influence the properties of the siloxanes, such as, for example, the elasticity, the electrical conductivity or the thermal conductivity. Fillers used may be any customary auxiliaries and reinforcing fillers; these may be, for example, silica, quartz, diatomaceous earth, color pigments, carbon blacks, etc.

A particularly suitable filler is silica, especially fumed silica, since the silirane groups are also able to enter, with addition reaction, into covalent bonds with the Si—OH groups on the filler surface. The covalent bonding to the filler particles is more stable than, for example, the interaction via van der Waals forces, as is the case with Pt-catalyzed crosslinking.

The reaction of silirane-functionalized compounds of the invention with functionalized siloxanes of the formula (VII) is accompanied by crosslinking if a difunctional silirane compound is reacted with a siloxane having at least three nucleophilic groups which are able to react with a silirane. Crosslinking likewise occurs if an at least trifunctional silirane compound is reacted with a siloxane having at least two nucleophilic groups which are able to react with a silirane.

With a difunctional silirane compound and a difunctional siloxane it is also possible to achieve chain extension without crosslinking, if the functional groups are in each case terminal.

A great advantage of this reaction is that it can be carried out without catalyst. It is possible nevertheless to accelerate the reaction by means of catalysts. Suitable catalysts include all compounds which activate siliranes but do not undergo addition to them. Examples of such catalysts are strong Lewis acids such as Cu(OTf)₂ and tris(pentafluorophenyl)borane (B(C₆F₅)₃) or frustrated Lewis acid base pairs such as triphenylmethyl tetrakis(pentafluorophenyl)borate.

The reaction of functionalized siloxanes of the formula (VII) with silirane-functionalized compounds of the invention constitutes an improvement on the conventional methods in a number of respects, as it combines the advantages of RTV-1 with RTV-2 systems. Since the reaction occurs only under thermal activation, the process can be carried out as a one-component system. The mixing of silirane-functionalized compound with siloxane may take place as early as before the reaction, and thus enables easy storage (analogously to RTV-1 systems). For this reason, the end user also requires no mixing tools on site and is not limited by a pot life. In addition, the ring-opening reaction of the siliranes constitutes an addition reaction and is consequently free from elimination products. In comparison to RTV-1 systems which are also one-component systems, the reaction with silirane-functionalized compounds does not form any volatile elimination products such as acetic acid, alcohol or the like. As a result of this there is no need for venting measures. The addition reaction also prevents the shrinking of the elastomer on curing, since in this case there is no loss of mass as a result of volatile elimination products (analogously to addition-crosslinking RTV-2). In the context of linking with the silirane-functionalized compounds of the invention, the film thickness is not a limiting factor as in the case of RTV-1, for example, since in this case the linking is not activated by atmospheric moisture and there are no elimination products needing to be outgassed. For these reasons, in the case of the silirane linking, the curing can also be activated very rapidly. There is no formation of bubbles here resulting from inclusion of the elimination products. A further key advantage of the silirane linking is that there is no need to use metal catalysts. Whereas RTV-2 systems are usually catalyzed using toxic or very expensive

Sn or Pt compounds, the silirane linking operates by simple thermal activation. The issue of the toxicity of catalysts and the recovery of expensive noble metal catalysts does not arise here. It is therefore likewise possible to rule out effects of “catalyst poisons”.

The siloxane bond (Si—O—Si) which is formed in the case of silirane linking between the reactants is a very stable chemical bond and continues the motif of the siloxane chain. This represents an advantage over the Pt-catalyzed RTV-2 (C₂H₄ bridges are formed) and over high-temperature crosslinking with peroxides (CₓH₂ₓ bridges are formed).

### EXAMPLES

All syntheses were carried out under Schlenk conditions in baked glass apparatus. The inert gas used was argon or nitrogen. Chemicals used (vinylsilanes, vinylsiloxanes, silicone oils, etc.) were acquired from Wacker Chemie AG, from ABCR or from Sigma-Aldrich. Cis-2-Butene (2.0) and trans-2-butene (2.0) were acquired from Linde AG. All solvents were dried and distilled before use. All silicone oils were dried over Al₂O₃ and 3 Å molecular sieve and degassed before use. The chemicals used were stored under inert gas. Lithium with 2.5% sodium fraction was obtained by melting elemental lithium (Sigma-Aldrich, 99%, trace metal basis) and sodium (Sigma-Aldrich 99.8%, sodium basis) at 200° C. in a nickel crucible under an argon atmosphere. Before being used, the Li/Na alloy was cut into extremely small pieces in order to increase the surface area. Al₂O₃ (neutral) and activated carbon were dried under a high vacuum at 150° C. for 72 hours.

Nuclear magnetic resonance spectroscopy (¹H, ²⁹Si) was carried out using a Bruker Avance III 500 MHz.

Mass spectrometry was carried out by means of CI-TOF at 150 eV using a Finnigan MAT90.

Shore A hardnesses were carried out using a Sauter HBA 100-0 and Zwick/Roell 3130 (measuring time 3 seconds; values reported are averages from 5 measurements).

Rheological investigations were carried out using an Anton Paar MCR 302 under inert gas.

Preparation of the Silirane Starting Compounds

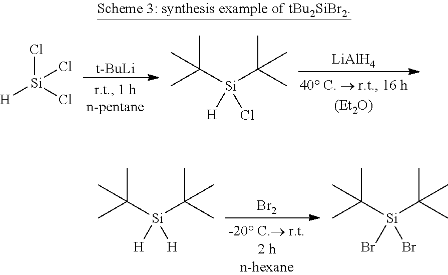

Synthesis of di-tert-butyldibromosilane

A 1 L three-neck flask with reflux condenser is charged with 582 mL (989 mmol, 2 equivalents) of tert-butyllithium (1.6 M in pentane). A dropping funnel is used to add 50.0 mL (495 mmol, 1 equivalent) of trichlorosilane slowly to the solution. The solution here is to gently boil and reflux. The reaction mixture is additionally stirred for an hour and then the solvent is removed under reduced pressure. The residue is purified by recondensation (10⁻³ mbar) with cold trap. Di-tert-butylchlorosilane (71.6 g, 81%) is obtained as a colorless liquid.

A 500 mL three-neck flask with reflux condenser is charged with 6.58 g (173 mmol, 0.4 equivalent) of lithium aluminum hydride in 50 mL of diethyl ether and heated to 40° C. 77.50 g of di-tert-butylchlorosilane are dissolved in 300 mL of diethyl ether in a dropping funnel and added slowly dropwise to the suspension. Following complete addition, the mixture is stirred for a further 16 hours at room temperature. The solvent is subsequently removed under reduced pressure. The residue is purified by recondensation (10⁻³ mbar) with cold trap. This gives 59.4 g (411.8 mmol, 95%) of di-tert-butylsilane as a colorless liquid.

A 500 mL three-neck flask is charged with 41.10 g (285 mmol, 1 equivalent) of di-tert-butylsilane in 200 mL of n-hexane and cooled to −20° C. 29.2 mL (569 mmol, 2 equivalents) of bromine are added dropwise via a dropping funnel to the solution. The HBr formed is captured using wash bottles and neutralized. The reaction mixture is stirred for a further 2 hours, in the course of which it is slowly thawed to room temperature. The solvent is subsequently removed under reduced pressure and the residue is purified by recondensation (60° C., 10⁻² mbar). The tBu₂SiBr₂ obtained is crystallized from dry MeCN at −20° C. before further use, to give a high-purity compound. This gives 78.6 g (260 mmol, 91%) of di-tert-butyldibromosilane as a colorless solid.

NMR: tBu₂SiHCl:

¹H-NMR: (300 K, 500 MHz, C₆D₆) δ=0.99 (s, 18H, tBu), 4.33 (s, 1H, Si—H).

²⁹Si-NMR: (300 K, 100 MHz, C₆D₆) δ=27.2.

NMR: tBu₂SiH₂:

¹H-NMR: (297 K, 300 MHz, C₆D₆) δ=1.04 (s, 18H, tBu), 3.66 (s, 2H, Si—H).

¹³C-NMR: (300 K, 125 MHz, C₆D₆) δ=17.8 (Si—C—), 28.9 (tBu-Me).

²⁹Si-NMR: (300 K, 100 MHz, C₆D₆) δ=1.58.

NMR: tBu₂SiBr₂:

¹H-NMR: (296 K, 300 MHz, C₆D₆) δ=1.05 (s, 18H, tBu).

¹³C-NMR: (300 K, 125 MHz, C₆D₆) δ=26.0 (Si—C—), 27.2 (tBu-Me)

²⁹Si-NMR: (300 K, 100 MHz, C₆D₆) δ=45.6.

### Synthesis of cis-1,1-di-tert-butyl-2,3-dimethylsilirane and trans-1,1-di-tert-butyl-2,3-dimethylsilirane

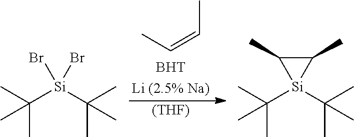

A thick-wall 500 mL Schlenk tube with screw lid (Teflon seal) is charged with 30.0 g (99.3 mmol, 1.0 equivalent) of di-tert-butyldibromosilane, which is dissolved in 17.5 g (198.6 mmol, 2 equivalents) of tetrahydrofuran. For stirring, a fairly large magnetic stirring rod with Teflon coating is selected. Added to the solution are 100 mg (0.45 mmol, 0.005 equivalent) of 3,5-di-tert-butyl-4-hydroxytoluene in order to suppress radical reactions. The flask is subsequently weighed. The solution is cooled to −78° C. in a dry ice-isopropanol cooling bath, and the argon present in the flask is removed by brief application of reduced pressure. By injection of around 1.8 bar of cis-2-butene into the reaction flask, 111.4 g (1.9 mol, 20.0 equivalents) of cis-2-butene are incorporated by condensation. The amount of cis-2-butene added is determined gravimetrically. The flask is then repressurized with argon and the screw closure is opened. In a countercurrent of argon, 5.51 g of finely cut lithium (2.5% Na, 794.4 mmol, 8.0 equivalents) are added. The flask is firmly closed again and the contents are thawed to room temperature with vigorous stirring over a period of 16 hours. This is followed by vigorous stirring at room temperature for a further 48 hours. Subsequent reaction monitoring may be carried out using ²⁹Si-NMR, for example. If conversion is complete, the cis-2-butene is slowly discharged from the flask until the flask is no longer under pressure. The tetrahydrofuran is removed under reduced pressure. The residue is extracted with 5 times 100 mL of pentane in order to remove the lithium bromide formed. The pentane is removed again under reduced pressure, and the oily residue is purified by flash distillation (40° C., 10⁻² mbar). The product is captured in this case in the collecting flask by nitrogen cooling. Distillation gives 14.4 g (72.6 mmol, 73%) of cis-1,1-di-tert-butyl-2,3-dimethylsilirane as a clear, colorless oil.

NMR: cis-tBu₂Si(CHMe)₂

¹H-NMR: (300 K, 500 MHz, C6D6) δ=1.06 (s, 9H, tBu), 1.04-1.10 (m, 2H, —Si—CH—), 1.17 (s, 9H, tBu), 1.40-1.41 (m, 6H, —CH-Me).

¹³C-NMR: (300 K, 125 MHz, C6D6) δ=10.0 (Si—CH—), 10.3 (Si—CH—), 18.6 (—CH-Me), 20.9 (—CH-Me), 30.0 (tBu-Me), 31.6 (tBu-Me).

²⁹Si-NMR: (300 K, 100 MHz, C6D6) δ=−53.2.

CI-MS: 197.3 [M]⁺.

trans-1,1-Di-tert-butyl-2,3-dimethylsilirane is synthesized analogously according to synthesis example 1, but in this case using trans-2-butene. The use of a cis/trans mixture is also possible, as in the subsequent reaction the two isomers are indistinguishable in terms of their reactivity.

NMR: trans-tBu₂Si(CHMe)₂

¹H-NMR: (297 K, 300 MHz, C₆D₆) δ=1.06 (s, 2H, —Si—CH—), 1.09 (s, 18H, tBu), 1.54-1.47 (m, 6H, —CHMe).

²⁹Si-NMR: (300 K, 100 MHz, C₆D₆) δ=−43.9.

CI-MS: 197.3 [M]⁺

### Example 1: Synthesis of 2,4,6,8-tetrakis(1,1-di-tert-butylsilirane-2-yl)-2,4,6,8-tetramethylcyclotetrasiloxane (D₄V1)

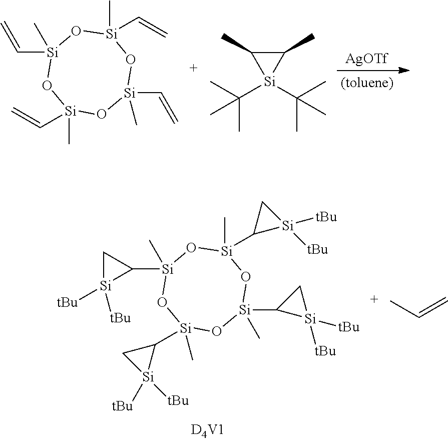

In a 20 mL Schlenk tube with Teflon-coated magnetic stirring bar, 987 mg (2.86 mmol, 1.0 equivalent) of 2,4,6,8-tetramethyltetravinylcyclotetrasiloxane and 2.50 g (12.6 mmol, 4.4 equivalents) of cis-1,1-di-tert-butyl-2,3-dimethylsilirane are dissolved in 5 ml of toluene. As a catalyst, with stirring, 1 mg (4.01 μmol, 0.0014 equivalent) of silver trifluoromethanesulfonate is added. The mixture is stirred at 60° C. for 4 hours. The 2-butene gas which is formed in this process must be able to escape via a pressure relief valve. Complete conversion can be verified via 1H-NMR (vinyl protons). The solvent and the excess monosilirane are subsequently removed under reduced pressure (60° C., 10⁻⁵ mbar). This gives 2.58 g (98%) of D₄V1 in the form of a viscous yellow oil. To remove the residues of catalyst, the oil is dissolved in 5 mL of pentane and filtered through Al₂O₃. After rinsing with 2 mL of pentane, the collected filtrate is filtered via a syringe filter. Removal of the solvent under reduced pressure gives 2.23 g (2.44 mmol, 85%) of 2,4,6,8-tetrakis(1,1-di-tert-butylsiliran-2-yl)-2,4,6,8-tetramethyl-cyclotetrasiloxane as a colorless viscous oil.

NMR: D₄V1

¹H-NMR: (300 K, 500 MHz, C₆D6) δ=−0.16-0.02 (m, 4H, —CH—), 0.46-0.66 (m, 12H, Si-Me), 0.77-0.88 (m, 8H, —CH₂—), 1.04-1.13 (m, 36H, tBu), 1.24-1.31 (m, 36H, tBu).

²⁹Si-NMR: (300 K, 100 MHz, C₆D₆) δ=−49.8-(−49.0) (—Si-tBu₂), −23.8-(−21.9) (—Si—O—).

CI-MS: 911.4[M]⁺, 769.8 [M-SitBu₂]⁺, 628.1 [M-2SitBu₂]⁺.

### Example 2: Synthesis of tetrakis((1,1-di-tert-butylsiliran-2-yl)methyl)silane (TAV1)

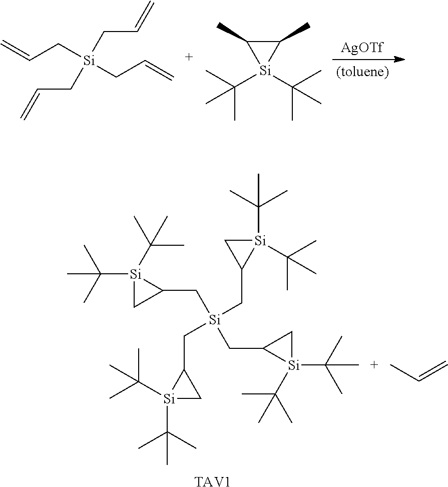

In a 20 mL Schlenk tube with Teflon-coated magnetic stirring bar, 661 mg (3.44 mmol, 1.0 equivalent) of tetraallylsilane and 3.00 g (15.1 mmol, 4.4 equivalents) of cis-1,1-di-tert-butyl-2,3-dimethylsilirane are dissolved in 5 ml of toluene. As a catalyst, with stirring, 1 mg (4.12 μmol, 0.0012 equivalent) of silver trifluoromethanesulfonate is added. The mixture is stirred at 60° C. for 4 hours. The 2-butene gas which is formed in this process must be able to escape via a pressure relief valve. Complete conversion can be verified via ¹H-NMR (vinyl protons). The solvent and the excess monosilirane are subsequently removed under reduced pressure (60° C., 10⁻⁵ mbar). This gives 2.46 g (94%) of TAV1 in the form of a viscous slightly brownish oil. To remove the residues of catalyst, the oil is dissolved in 5 mL of pentane and filtered through Al₂O₃. After rinsing with 2 mL of pentane, the collected filtrate is filtered via a syringe filter. Removal of the solvent under reduced pressure gives 2.15 g (2.82 mmol, 82%) of tetrakis((1,1-di-tert-butylsiliran-2-yl)methyl)silane as a colorless viscous oil.

NMR: TAV1

¹H-NMR: (300 K, 500 MHz, C₆D₆) δ=0.39-0.44 (m, 4H, tBu₂SiCH), 1.10-1.11 (m, 36H, tBu), 1.19-1.22 (m, 8H, Si(CH₂)₄), 1.25-1.26 (m, 36H, tBu), 1.40-1.47 (m, 4H, tBu₂SiCH₂), 1.60-1.66 (m, 4H, tBu₂SiCH₂).

²⁹Si-NMR: (300 K, 100 MHz, C₆D₆) δ=5.0 (Si—(CH₂)₄—), −49.5 (—Si-tBu₂).

CI-MS: 760.0[M]⁺, 285.2 [Si₂tBu₄a]⁺.

### Example 3: Synthesis of poly(((1,1-di-tert-butylsiliran-2-yl)methylsiloxane)-co-dimethylsiloxane) Copolymer (VMS14V1)

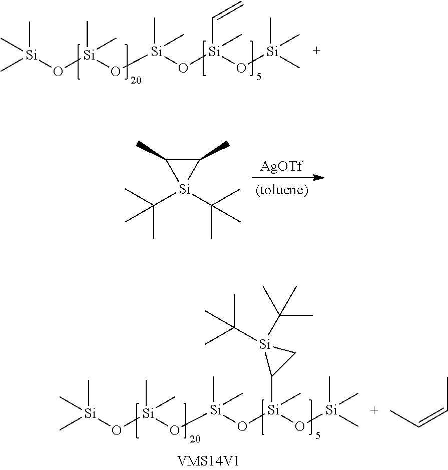

In a 20 mL Schlenk tube with Teflon-coated magnetic stirring bar, 8.00 g (3.72 mmol, 1.0 equivalent) of (vinylmethylsiloxane)-dimethylsiloxane copolymer (M_{w}=2.150 g/mol, 18% vinylmethylsiloxane) and 4.06 g (20.46 mmol, 5.5 equivalents) of cis-1,1-di-tert-butyl-2,3-dimethylsilirane are dissolved in 5 ml of toluene. As a catalyst, with stirring, 1 mg (4.09 μmol, 0.0011 equivalent) of silver trifluoromethanesulfonate is added. The mixture is stirred at 60° C. for 4 hours. The 2-butene gas which is formed in this process must be able to escape via a pressure relief valve. Complete conversion can be verified via 1H-NMR (vinyl protons). The solvent and the excess monosilirane are subsequently removed under reduced pressure (60° C., 10⁻⁵ mbar). This gives 10.31 g (96%) of VMS14V1 in the form of a viscous slightly brownish oil. To remove the residues of catalyst, the oil is dissolved in 5 mL of pentane and filtered through Al₂O₃. After rinsing with 2 mL of pentane, the collected filtrate is filtered via a syringe filter. Removal of the solvent under reduced pressure gives 6.23 g (2.18 mmol, 58%) of poly(((1,1-di-tert-butylsiliran-2-yl)methylsiloxane)-co-dimethylsiloxane) as a colorless viscous oil.

NMR: VMS14V1

¹H-NMR: (300 K, 500 MHz, C₆D₆) δ=−0.18 (m, 5H, tBu₂SiCH), 0.17-0.56 (m, 159H, Si-Me), 0.70-0.87 (m, 10H, tBu₂SiCH₂) 1.06-1.17 (m, 45H, tBu), 1.21-1.34 (m, 45H, tBu).

²⁹Si-NMR: (300 K, 100 MHz, C₆D₆) δ=−21.3-22.7 (—SiMe₂-O—), −23.66 (—SiMeR—O—), −49.17 (—SitBu₂).

### Use Example 1: Linking of Polydimethylsiloxane (Silanol Terminated, n=132) with tetrakis((1,1-di-tert-butylsiliran-2-yl)methyl)silane (TAV1)

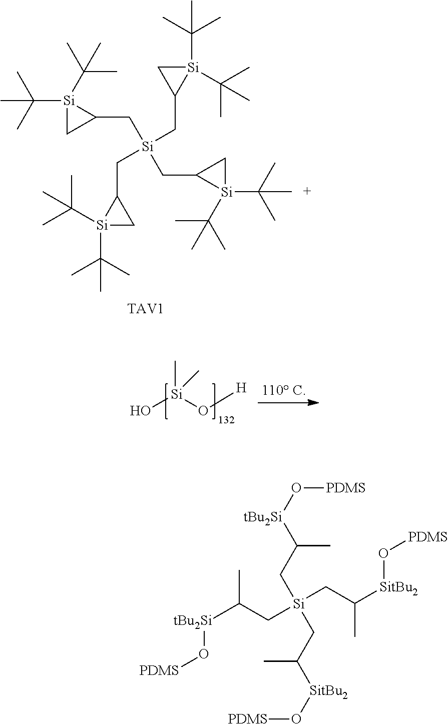

A suitable vessel is charged with TAV1 (100 mg, 131.3 μmol, 1.0 equivalent) and silicone oil (2.58 g, 262.6 μmol, 2.0 equivalents, 9800 g/mol, Si—OH terminated) in a molar ratio of 1:1 (silirane groups:Si—OH) under inert gas. The mixture is heated to 100° C. and stirred with a magnetic stirring bar until homogeneous mixing is ensured. Crosslinking takes place at 110° C. for 24 hours under inert gas. The product is a clear, colorless and elastic polymer which is not sticky and has a Shore A hardness of 16.5.

### Use Example 2: Linking of Polydimethylsiloxane (Silanol Terminated, n=132) with poly(((1,1-di-tert-butylsiliran-2-yl)methylsiloxane)-co-dimethylsiloxane) Copolymer (VMS14V1)

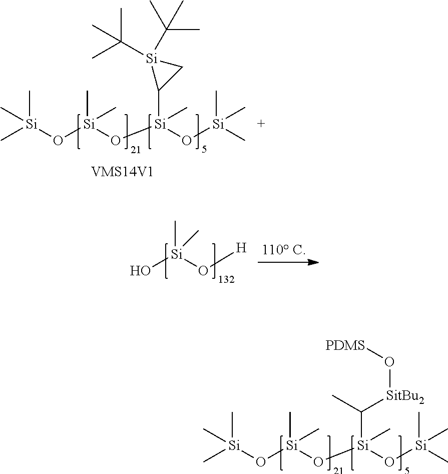

A suitable vessel is charged with VMS14V1 (200 mg, 69.9 μmol, 1.0 equivalent) and silicone oil (1.71 g, 174.7 μmol, 2.5 equivalents, 9800 g/mol, Si—OH terminated) in a molar ratio of 1:1 (silirane groups:Si—OH) under inert gas. The mixture is heated to 100° C. and stirred with a magnetic stirring bar until homogeneous mixing is ensured. Crosslinking takes place at 110° C. for 24 hours under inert gas. The product is a clear, colorless and elastic polymer which is not sticky and has a Shore A hardness of 9.8.

### Use Example 3: Linking of Polydimethylsiloxane (Silanol Terminated, n=132) with 2,4,6,8-tetrakis(1,1-di-tert-butylsiliran-2-yl)-2,4,6,8-tetramethylcyclotetrasiloxane (D₄V1)

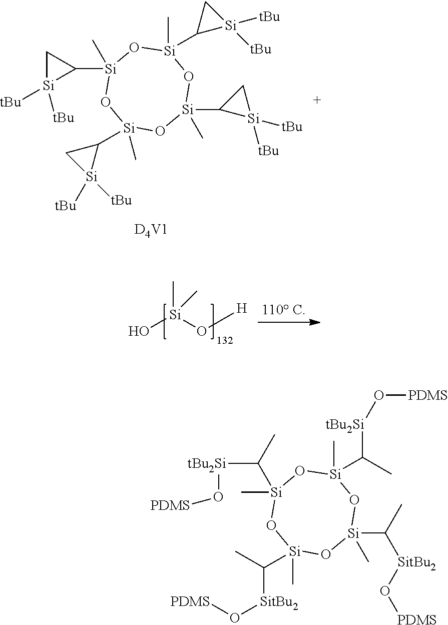

A suitable vessel is charged with D₄V1 (466 mg, 509.9 μmol, 1.0 equivalent) and silicone oil (10.0 g, 1.02 mmol, 2.0 equivalents, 9800 g/mol, Si—OH terminated) in a molar ratio of 1:1 (silirane groups:Si—OH) under inert gas. The mixture is heated to 100° C. and stirred with a magnetic stirring bar until homogeneous mixing is ensured. Crosslinking takes place at 110° C. for 24 hours under inert gas. The product is a clear, colorless and elastic polymer which is not sticky and has a Shore A hardness of 9.1.

### Use Example 4: Linking of Polydimethylsiloxane (Propylamine Terminated, n=15) with poly(((1,1-di-tert-butylsiliran-2-yl)methylsiloxane)-co-dimethylsiloxane) Copolymer (VMS14V1)

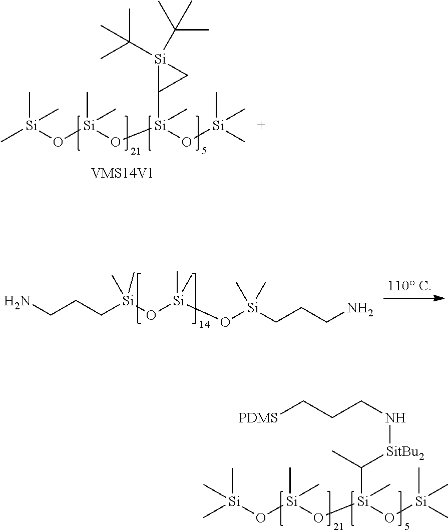

A suitable vessel is charged with VMS14V1 (500 mg, 174.7 μmol, 1.0 equivalent) and silicone oil (450 g, 349.4 μmol, 2.0 equivalents, 1286 g/mol, propylamine terminated) in a molar ratio of 1.25:1 (silirane groups-NH₂) under inert gas. The mixture is heated to 100° C. and stirred with a magnetic stirring bar until homogeneous mixing is ensured. Crosslinking takes place at 110° C. for 24 hours under inert gas. The product is a clear, colorless and elastic polymer which is not sticky and has a Shore A hardness of 27.5.

### Use Example 5: Linking of Polydimethylsiloxane (Hydroxymethyl Terminated, n=181) with 2,4,6,8-tetrakis(1,1-di-tert-butylsiliran-2-yl)-2,4,6,8-tetramethylcyclotetrasiloxane (D₄V1)

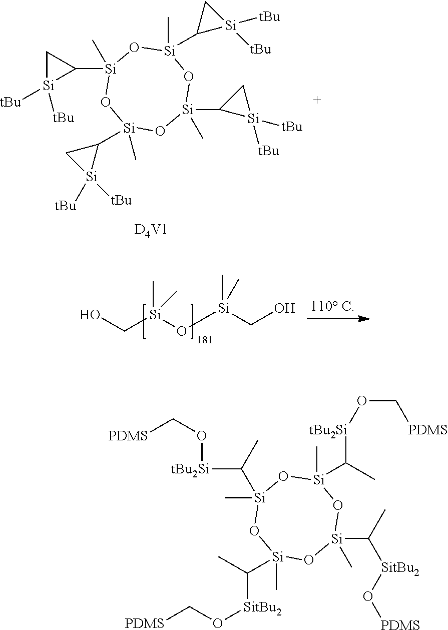

A suitable vessel is charged with D₄V1 (67.4 mg, 73.8 μmol, 1.0 equivalent) and silicone oil (2.0 g, 147.5 mmol, 2.0 equivalents, 13 540 g/mol, Si—CH₂OH terminated) in a molar ratio of 1:1 (silirane groups:Si—CH₂OH) under inert gas. The mixture is heated to 100° C. and stirred with a magnetic stirring bar until homogeneous mixing is ensured. Crosslinking takes place at 110° C. for 24 hours under inert gas. The product is a clear, colorless and elastic polymer which is not sticky and has a Shore A hardness of 4.1.

### Use Example 6: Linking of Polydimethylsiloxane (Silanol Terminated, n=486) with poly(((1,1-di-tert-butylsiliran-2-yl)methylsiloxane)-co-dimethylsiloxane) Copolymer (ViSi30KV1)

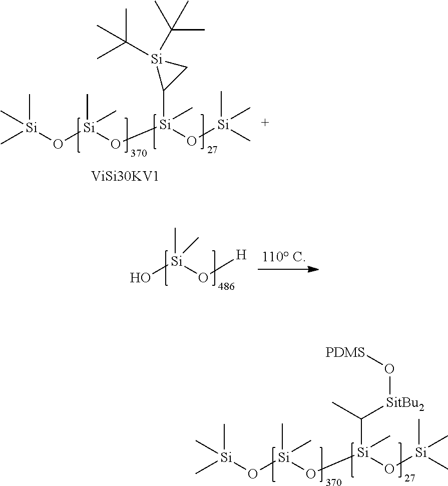

A suitable vessel is charged with ViSi30KV1 (150 mg, 4.42 μmol, 1.0 equivalent, 33 940 g/mol) and silicone oil (2.19 g, 60.77 μmol, 13.75 equivalents, 36 000 g/mol, Si—OH terminated) in a molar ratio of 1:1 (silirane groups:Si—OH) under inert gas. The mixture is heated to 100° C. and stirred with a magnetic stirring bar until homogeneous mixing is ensured. Crosslinking takes place at 110° C. for 24 hours under inert gas. The product is a clear, colorless and elastic polymer which is not sticky and has a Shore A hardness of 7.

### Use Example 7: Linking of a Mixture of Polydimethylsiloxane (Silanol Terminated, n=132) and tetrakis((1,1-di-tert-butylsiliran-2-yl)methyl)-silane (TAV1) by Catalysis at Room Temperature

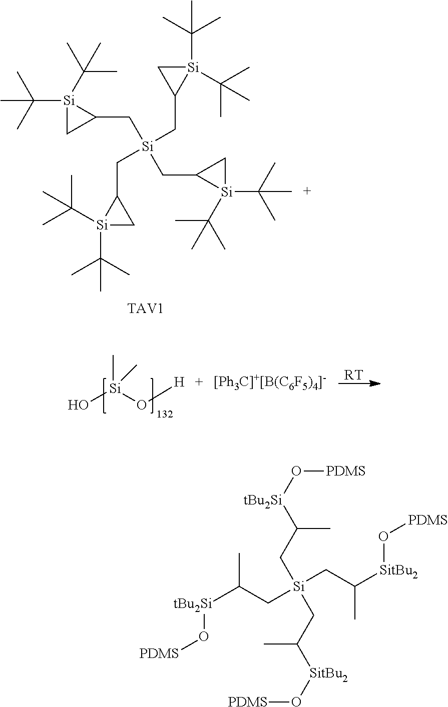

A suitable vessel is charged with TAV1 (100 mg, 131.3 μmol, 1.0 equivalent) and silicone oil (2.58 g, 262.6 μmol, 2.0 equivalents, 9800 g/mol, Si—OH terminated) in a molar ratio of 1:1 (silirane groups:Si—OH) under inert gas. Additionally added as crosslinking catalyst are 1.20 mg 1.3 μmol, 0.01 equivalent) of triphenylmethyl tetrakis(pentafluorophenyl)borate. The mixture is stirred at room temperature by means of a magnetic stirring bar until homogeneous mixing is ensured. Crosslinking takes place at room temperature (23° C.) for 1 hour under inert gas. The product is a clear, pale brown and elastic polymer which is not sticky.

### Analytical Example 1: (Rheological Study of the Linking of VMS14V1 and Silicone Oil (n=132, Si—OH Terminated)

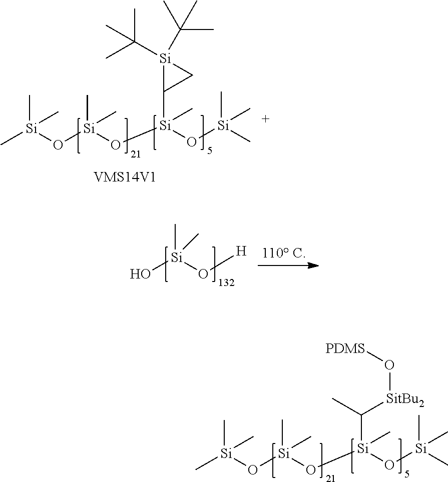

The crosslinking reaction from use example 2 was carried out in multiple mixing proportions, with the mixing proportion relating to the amount-of-substance ratio of silirane groups to silanol groups. The mixing of the components and their transfer into the rheometer took place under inert gas. Crosslinking took place in the rheometer at 110° C. under nitrogen.

TABLE 1
crosslinking experiments conducted with
VMS14V1 in a rheometer at 110° C.

| | Silicone oil (9800 g/mol, | |
|---|---|---|
| Compound VMS14V1 | Si—OH terminated) | Ratio silirane/Si—OH |
| 100 mg | 1220 mg | 0.7 |
| 100 mg | 949 mg | 0.9 |
| 100 mg | 857 mg | 1 |
| 100 mg | 613 mg | 1.4 |
| 100 mg | 476 mg | 1.8 |

The crosslinking time can be estimated by the change over time in the viscosity of the mixtures. The crosslinking time is observed to fall as the silirane fraction rises. Beyond a mixing proportion of 1:1, the mixtures are crosslinked after 16-24 hours at 110° C. The highest viscosity is achieved with a ratio of ˜1.4.

The loss factor tan(δ), which represents the ratio of loss modulus G″ to storage modulus G′, is a measure of the viscoelastic properties of a material. The lower tan(6), the less energy is lost in elastic processes. tan(δ)=0 denotes ideally elastic behavior. The tan(δ) values represented in table 2 (mean values of the last 100 measurement points) are a measure of the elastic properties and of the degree of crosslinking of the through-crosslinked mixtures. The lowest tan(δ) value is achieved with a 1:1 mixture; this points to a very high degree of crosslinking. In the case of undercrosslinked mixtures (ratio=0.7/0.9), higher loss factors are obtained.

TABLE 2
loss factor tan(δ) for various through-crosslinked elastomers

| Ratio silirane/Si—OH | Loss factor tan(δ) |
|---|---|
| 0.7 | 0.0205 |
| 0.9 | 0.0029 |
| 1 | 0.0016 |
| 1.4 | 0.0017 |
| 1.8 | 0.0020 |

### Analytical Example 2: Investigation of the Shore A Hardness of Different Mixtures of Silirane Compound and Silicone Oils

The Shore A hardness was determined by crosslinking mixtures of silirane compound and Si—OH terminated silicone oils at 110° C. for 72 hours in order to ensure complete conversion. The Shore A hardness was measured directly after crosslinking and again 8 weeks after; no difference was found in this case.

TABLE 3
Shore-A hardnesses of elastomers formed from
various silirane compounds and silicone oils.

| | | Mixing proportion | |
|---|---|---|---|
| | | (silirane groups/ | |
| Silirane | Silicone oil | functional groups | Shore A |
| compound | (dimethylsiloxane) | in silicone oil) | hardness |
| TAV1 | 9800 g/mol, Si—OH | 1.0 | 17 |
| | terminated | | |
| TAV1 | 9800 g/mol, Si—OH | 1.1 | 15 |
| | terminated | | |
| TAV1 | 9800 g/mol, Si—OH | 1.3 | 6 |
| | terminated | | |
| TAV1 | 9800 g/mol, Si—OH | 1.5 | 1-2 |
| | terminated | | |
| VMS14V1 | 9800 g/mol, Si—OH | 1.0 | 10 |
| | terminated | | |
| VMS14V1 | 9800 g/mol, Si—OH | 1.3 | 5 |
| | terminated | | |
| VMS14V1 | 9800 g/mol, Si—OH | 1.5 | 0-1 |
| | terminated | | |
| ViSi30KV1 | 36 000 g/mol, Si—OH | 1.0 | 7 |
| | terminated | | |
| ViSi30KV1 | 36 000 g/mol, Si—OH | 1.3 | 16 |
| | terminated | | |
| ViSi30KV1 | 36 000 g/mol, Si—OH | 1.5 | 19 |
| | terminated | | |
| ViSi30KV1 | 36 000 g/mol, Si—OH | 2.0 | 27 |
| | terminated | | |
| ViSi30KV1 | 9800 g/mol, Si—OH | 1.0 | 28 |
| | terminated | | |
| ViSi30KV1 | 9800 g/mol, Si—OH | 1.3 | 33 |
| | terminated | | |
| ViSi30KV1 | 9800 g/mol, Si—OH | 1.5 | 24 |
| | terminated | | |

1-14. (canceled)

15. A silirane-functionalized compound consisting of a substrate to which at least two silirane groups of the formula (I) 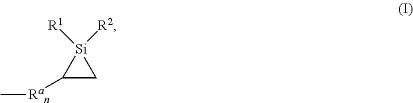
are covalently bonded,
where in formula (I) the index n adopts a value of 0 or 1,
and where the radical IV is a divalent C₁-C₂₀ hydrocarbon radical,
and where the radicals R¹ and R² independently of one another are selected from the group consisting of (i) hydrogen, (ii) C₁-C₂₀ hydrocarbon radical, (iii) silyl radical —SiR^{a}R^{b}R^{c}, in which the radicals R^{a},R^{b},R^{c} independently of one another are a C₁-C₆ hydrocarbon radical, (iv) amine radical —NR′R″ in which the radicals R′,R″ independently of one another are selected from the group consisting of (iv.i) hydrogen, (iv.ii) C₁-C₂₀ hydrocarbon radical and (iv.iii) silyl radical —SiR^{a}R^{b}R^{c}, in which the radicals R^{a},R^{b},R^{c} independently of one another are a C₁-C₆ hydrocarbon radical, and (v) imine radical —N═CR¹R², in which the radicals R¹,R² independently of one another are selected from the group consisting of (v.i) hydrogen, (v.ii) C₁-C₂₀ hydrocarbon radical and (v.iii) silyl radical —SiR^{a}R^{b}R^{c}, in which the radicals R^{a},R^{b},R^{c} independently of one another are a C₁-C₆ hydrocarbon radical.

16. The silirane-functionalized compounds as claimed in claim 15, characterized in that the substrate is selected from the group consisting of organosilicon compounds, hydrocarbons, silicas, glass, sand, stone, metals, semimetals, metal oxides, mixed metal oxides, and carbon-based oligomers and polymers.

17. The silirane-functionalized compounds as claimed in claim 16, characterized in that the substrate is selected from the group consisting of silanes, siloxanes, precipitated silica, fumed silica, glass, hydrocarbons, polyolefins, acrylates, polyacrylates, polyvinyl acetates, polyurethanes and polyethers composed of propylene oxide and/or ethylene oxide units.

18. The silirane-functionalized compounds as claimed in claim 15, characterized in that they are silirane-functionalized organosilicon compounds selected from the group consisting of
(a) compounds of the general formula (II)
SiR′ₙR₄₋ₙ (II),
in which the index n adopts the value of 2, 3 or 4, and the radicals R independently of one another are selected from the group consisting of (i) hydrogen, (ii) halogen, (iii) unsubstituted or substituted C₁-C₂₀ hydrocarbon radical and (iv) unsubstituted or substituted C₁-C₂₀ hydrocarbonoxy radical;
and in which the radicals R′ are a silirane group of the formula (II′) 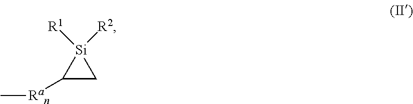
in which the index n adopts the value of 0 or 1;
in which the radical R^{a} is a divalent C₁-C₂₀ hydrocarbon radical;
and in which the radicals R¹ and R² independently of one another are selected from the group consisting of (i)
(hydrogen), (ii) C₁-C₂₀ hydrocarbon radical, (iii) silyl radical —SiR^{a}R^{b}R^{c}, in which the radicals R^{a},R^{b},R^{c} independently of one another are a C₁-C₆ hydrocarbon radical, (iv) amine radical —NR′R″, in which the radicals R′,R″ independently of one another are selected from the group consisting of (iv.i) hydrogen, (iv.ii) C₁-C₂₀ hydrocarbon radical and (iv.iii) silyl radical —SiR^{a}R^{b}R^{c}, in which the radicals R^{a},R^{b},R^{c} independently of one another are a C₁-C₆ hydrocarbon radical, and (v) imine radical —N═CR¹R², in which the radicals R¹,R² independently of one another are selected from the group consisting of (v.i) hydrogen, (v.ii) C₁-C₂₀ hydrocarbon radical and (v.iii) silyl radical —SiR^{a}R^{b}R^{c}, in which the radicals R^{a},R^{b},R^{c} independently of one another are a C₁-C₆ hydrocarbon radical; or
(b) compounds of the general formula (III)
(SiO_{4/2})ₐ(R^{x}SiO_{3/2})_{b}(R′SiO_{3/2})_{b′}(R^{x}₂SiO_{2/2})_{c}(R^{x}R′SiO_{2/2})_{c′}(R′₂SiO_{2/2})_{c″}(R^{x}₃SiO_{1/2})_{d}(R′R^{x}₂SiO_{1/2})_{d′}(R′₂R^{x}SiO_{1/2})_{d″}(R′₃SiO_{1/2})_{d′″} (III),
in which the radicals R^{x} independently of one another are selected from the group consisting of (i) hydrogen, (ii) halogen, (iii) unsubstituted or substituted C₁-C₂₀ hydrocarbon radical and (iv) unsubstituted or substituted C₁-C₂₀ hydrocarbonoxy radical; and in which the indices a, b, b′, c, c′, c″, d, d′, d″, d′″ indicate the number of the respective siloxane unit in the compound and independently of one another are an integer in the range from 0 to 100 000, with the proviso that the sum of a, b, b′, c, c′, c″, d, d′, d″, d′″ together adopts a value of at least 2 and at least one of the indices b′, c′, d′ is ≥2 or at least one of the indices c″, d″ or d′″ is other than 0;
and the radicals R′ are a silirane group of the formula (III′) 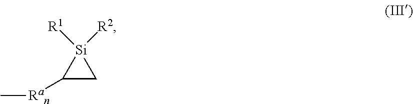
in which the index n adopts the value of 0 or 1;
in which the radical IV is a divalent C₁-C₂₀ hydrocarbon radical;
and in which the radicals R¹ and R² independently of one another are selected from the group consisting of (i)
hydrogen, (ii) C₁-C₂₀ hydrocarbon radical, (iii) silyl radical —SiR^{a}R^{b}R^{c}, in which the radicals R^{a},R^{b},R^{c} independently of one another are a C₁-C₆ hydrocarbon radical, (iv) amine radical —NR′R″, in which the radicals R′,R″ independently of one another are selected from the group consisting of (iv.i) hydrogen, (iv.ii) C₁-C₂₀ hydrocarbon radical and (iv.iii) silyl radical —SiR^{a}R^{b}R^{c}, in which the radicals R^{a},R^{b},R^{c} independently of one another are a C₁-C₆ hydrocarbon radical, and (v) imine radical —N═CR¹R², in which the radicals R¹,R² independently of one another are selected from the group consisting of (v.i) hydrogen, (v.ii) C₁-C₂₀ hydrocarbon radical and (v.iii) silyl radical —SiR^{a}R^{b}R^{c}, in which the radicals R^{a},R^{b},R^{c} independently of one another are a C₁-C₆ hydrocarbon radical.

19. The silirane-functionalized compounds as claimed in claim 18, where
(a) in formula (II) the index n adopts the value of 4 and in formula (II′) the radicals R¹ and R² are selected from the group consisting of (i) hydrogen, (ii) C₁-C₆ alkyl radical, (iii) phenyl radical, (iv) —SiMe₃, and (v) —N(SiMe₃)₂; and
(b) in formula (III) the radicals R′ independently of one another are selected from the group consisting of (i) hydrogen, (ii) chlorine, (iii) C₁-C₆-alkyl, (iv) C₁-C₆ alkylene, (v) phenyl, and (vi) C₁-C₆ alkoxy and in formula (III′) the radicals R¹ and R² independently of one another are selected from the group consisting of (i) hydrogen, (ii) C₁-C₆ alkyl radical, (iii) phenyl radical, (iv)
—SiMe₃, and (v) —N(SiMe₃)₂.

20. The silirane-functionalized compounds as claimed in claim 19, where
(a) in formula (II) the radicals R′ are identical, in formula (II′) the radical IV is a divalent C₁-C₃ hydrocarbon radical and the radicals R¹ and R² independently of one another are selected from the group consisting of methyl, ethyl, tert-butyl, sec-butyl, cyclohexyl, —SiMe₃, and —N(SiMe₃)₂; and
(b) in formula (III) the radicals R′ independently of one another are selected from the group consisting of methyl, methoxy, ethyl, ethoxy, propyl, propoxy, phenyl and chlorine and in formula (III′) the radical R^{a} is a divalent C₁-C₃ hydrocarbon radical and the radicals R¹ and R² independently of one another are selected from the group consisting of methyl, ethyl, tert-butyl, sec-butyl, cyclohexyl, —SiMe₃, and —N(SiMe₃)₂.

21. A process for preparing silirane-functionalized compounds, comprising the steps of
(a) providing a silirane of the general formula (IV) 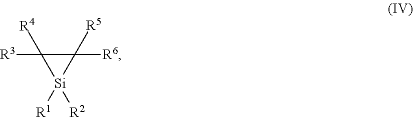
in which the radicals R¹ and R² independently of one another are selected from the group consisting of (i) hydrogen, (ii) C₁-C₂₀ hydrocarbon radical, (iii) silyl radical —SiR^{a}R^{b}R^{c}, in which the radicals R^{a},R^{b},R^{c} independently of one another are a C₁-C₆ hydrocarbon radical, (iv) amine radical —NR¹R², in which the radicals R¹R² independently of one another are selected from the group consisting of (iv.i) hydrogen, (iv.ii) C₁-C₂₀ hydrocarbon radical and (iv.iii) silyl radical —SiR^{a}R^{b}R^{c}, in which the radicals R^{a},R^{b},R^{c} independently of one another are a C₁-C₆ hydrocarbon radical, and (v) imine radical —N═CR¹R², in which the radicals R¹,R² independently of one another are selected from the group consisting of (v.i) hydrogen, (v.ii) C₁-C₂₀ hydrocarbon radical and (v.iii) silyl radical —SiR^{a}R^{b}R^{c}, in which the radicals R^{a},R^{b},R^{c} independently of one another are a C₁-C₆ hydrocarbon radical; and
in which the radicals R³, R⁴, R⁵, R⁶ independently of one another are selected from the group consisting of (i) hydrogen, (ii) C₁-C₂₀ hydrocarbon radical, and (iii) silyl radical —SiR^{a}R^{b}R^{c}, in which the radicals R^{a},R^{b},R^{c} independently of one another are a C₁-C₆ hydrocarbon radical;
(b) reacting the silirane from (a) with a substrate that has at least two covalently bonded carbon-carbon double bonds, of the formula —R^{a}ₙ—CR═CR², in which R^{a} is a divalent C₁-C₂₀ hydrocarbon radical and the index n adopts the values of 0 or 1, and in which the radicals R independently of one another are selected from the group consisting of (i) hydrogen and (ii) C₁-C₆ hydrocarbon radical.

22. A process for preparing a silirane-functionalized compound according to claim 18, comprising the steps of
(a) providing a silirane of the general formula (IV) 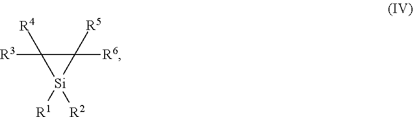
in which the radicals R¹ and R² independently of one another are selected from the group consisting of (i) hydrogen, (ii) C₁-C₂₀ hydrocarbon radical, (iii) silyl radical —SiR^{a}R^{b}R^{c}, in which the radicals R^{a},R^{b},R^{c} independently of one another are a C₁-C₆ hydrocarbon radical, (iv) amine radical —NR¹R², in which the radicals R¹R² independently of one another are selected from the group consisting of (iv.i) hydrogen, (iv.ii) C₁-C₂₀ hydrocarbon radical and (iv.iii) silyl radical —SiR^{a}R^{b}R^{c}, in which the radicals R^{a},R^{b},R^{c} independently of one another are a C₁-C₆ hydrocarbon radical, and (v) imine radical —N═CR¹R², in which the radicals R¹,R² independently of one another are selected from the group consisting of (v.i) hydrogen, (v.ii) C₁-C₂₀ hydrocarbon radical and (v.iii) silyl radical —SiR^{a}R^{b}R^{c}, in which the radicals R^{a},R^{b},R^{c} independently of one another are a C₁-C₆ hydrocarbon radical; and
in which the radicals R³, R⁴, R⁵, R⁶ independently of one another are selected from the group consisting of (i) hydrogen, (ii) C₁-C₂₀ hydrocarbon radical, and (iii) silyl radical —SiR^{a}R^{b}R^{c}, in which the radicals R^{a},R^{b},R^{c} independently of one another are a C₁-C₆ hydrocarbon radical;
(b) reacting the silirane from (a) with a substrate selected from the group consisting of (i) olefinically functionalized silanes of the general formula (V)
SiR⁷ₙR₄₋ₙ (V),
in which the index n adopts the values of 2, 3 or 4; and in which the radicals R independently of one another are selected from the group consisting of (i) hydrogen, (ii) halogen, (iii) unsubstituted or substituted C₁-C₂₀ hydrocarbon radical and (iv) unsubstituted or substituted C₁-C₂₀ hydrocarbonoxy radical; and
in which the radicals R⁷ independently of one another are selected from radicals —R^{a}ₙ—CR═CR², in which R^{a} is a divalent C₁-C₂₀ hydrocarbon radical and the index n adopts the values of 0 or 1 and the radicals R independently of one another are selected from the group consisting of (i) hydrogen and (ii) C₁-C₆ hydrocarbon radical; or
(ii) olefinically functionalized siloxanes of the general formula (VI)
(SiO_{4/2})ₐ(R^{x}SiO_{3/2})_{b}(R⁷SiO_{3/2})_{b′}(R^{x}₂SiO_{2/2})_{c}(R^{x}R⁷SiO_{2/2})_{c′}(R⁷₂SiO_{2/2})_{c″}(R^{x}₃SiO_{1/2})_{d}(R⁷R^{x}₂SiO_{1/2})_{d′}(R⁷₂R^{x}SiO_{1/2})_{d″}(R⁷₃SiO_{1/2})_{d′″} (VI),
in which the radicals R⁷ independently of one another are selected from radicals —R^{a}ₙ—CR═CR², in which R^{a} is a divalent C₁-C₂₀ hydrocarbon radical and the index n adopts the values of 0 or 1 and the radicals R independently of one another are selected from the group consisting of (i) hydrogen and (ii) C₁-C₆ hydrocarbon radical; and
in which the radicals R^{x} independently of one another are selected from the group consisting of (i) hydrogen, (ii) halogen, (iii) unsubstituted or substituted C₁-C₂₀ hydrocarbon radical and (iv) unsubstituted or substituted C₁-C₂₀ hydrocarbonoxy radical;
and in which the indices a, b, b′, c, c′, c″, d, d′, d″, d′″ indicate the number of the respective siloxane unit in the compound and independently of one another are an integer in the range from 0 to 100 000, with the proviso that the sum of a, b, b′, c, c′, c″, d, d′, d″, d′″ together adopts a value of at least 2 and at least one of the indices b′, c′, d′ is ≥2 or at least one of the indices c″, d″ or d′″ is other than 0; or
(c) allyl- and/or vinyl-terminated polyethers composed of propylene and/or ethylene oxide units.

23. A mixture comprising
a) at least one silirane-functionalized compound as claimed in claim 15; and
b) at least one compound A which has in each case at least two radicals R′, where the radicals R′ independently of one another are selected from the group consisting of (i) —OH, (ii) —CₓH₂ₓ—OH, in which x is an integer in the range of 1-20, (iii) —CₓH₂ₓ—NH₂, in which x is an integer in the range of 1-20, and (iv) —SH.

24. The mixture as claimed in claim 23, where the compound A is selected from functionalized siloxanes of the general formula (VII)
(SiO_{4/2})ₐ(R^{x}SiO_{3/2})_{b}(R′SiO_{3/2})_{b′}(R^{x}₂SiO_{2/2})_{c}(R^{x}R′SiO_{2/2})_{c′}(R′₂SiO_{2/2})_{c″}(R^{x}₃SiO_{1/2})_{d}(R′R^{x}₂SiO_{1/2})_{d′}(R′₂R^{x}SiO_{1/2})_{d″}(R′₃SiO_{1/2})_{d′″} (VII),
where the radicals R^{x} independently of one another are selected from the group consisting of (i) hydrogen, (ii) halogen, (iii) unsubstituted or substituted C₁-C₂₀ hydrocarbon radical and (iv) unsubstituted or substituted C₁-C₂₀ hydrocarbonoxy radical;
and where the radicals R′ independently of one another are selected from the group consisting of (i) —OH, (ii) —CₓH₂ₓ—OH, in which x is an integer in the range of 1-20, (iii) —CₓH₂ₓ—NH₂, in which x is an integer in the range of 1-20, and (iv) —SH;
and where the indices a, b, b′, c, c′, c″, d, d′, d″, d′″ indicate the number of the respective siloxane unit in the compound and independently of one another are an integer in the range from 0 to 100 000, with the proviso that the sum of a, b, b′, c, c′, c″, d, d′, d″, d′″ together adopts a value of at least 2 and at least one of the indices b′, c′, d′ is ≥2 or at least one of the indices c″, d″ or d′″ is other than 0.

25. A process for preparing siloxanes, comprising the following steps:
(i) providing a mixture as claimed in claim 23, and
(ii) reacting the mixture at a temperature in the range from 25° C. to 250° C.

26. The process as claimed in claim 25, where the molar ratio of silirane groups to functional groups in the siloxane is in a range of 4:1-1:4.

27. The process as claimed in claim 25, where additionally a catalyst is added.
